(19) United States
(12) Patent Application Publication
(10) Pub. No.: US 2026/0343122 A1
(43) Pub. Date: Oct. 29, 2026

(54) COUNTING MODE DECISION CIRCUITRY AND COUNTING MODE DECISION METHOD

(71) Applicant: Sony Semiconductor Solutions Corporation, Atsugi-shi, Kanagawa (JP)

(72) Inventor: Qing DING, Basingstoke (GB)

(73) Assignee: Sony Semiconductor Solutions Corporation, Atsugi-shi, Kanagawa (JP)

(21) Appl. No.: 19/115,265

(22) PCT Filed: Sep. 22, 2023
(86) PCT No.: PCT/EP2023/076215

§ 371 Date: Mar. 26, 2025

(30) Foreign Application Priority Data
Oct. 6, 2022 (EP) 22200058.0

(51) Int. Cl. H04N 25/42

(52) U.S. Cl. CPC H04N 25/42

(57) ABSTRACT

The present disclosure generally pertains to counting mode decision circuitry configured to: determine, for at least one imaging element, a photon number in a first photon counting mode of at least two photon counting modes which, in a standard operation mode, are applied after each other; and skip a second photon counting mode of the at least two photon counting modes, if the photon number in the first photon counting mode exceeds a predetermined threshold, thereby deviating from the standard operation mode.

### TECHNICAL FIELD

The present disclosure generally pertains to counting mode decision circuitry and a counting mode decision method for deciding a photon counting mode.

### TECHNICAL BACKGROUND

Generally, photon counting methods are known. Such technology may rely on the use of photo diodes, such as SPADs (single photon avalanche diodes), or the like.

SPADs may be biased in Geiger mode and may have significant gains in order to count (single photon), such that a SPAD may be used for low light conditions.

Moreover, it is known to combine SPAD based photon counting with a high dynamic range photo detection, e.g., by adopting two different exposure times, such as a long exposure and a short exposure.

Although there exist techniques for photon counting, it is generally desirable to provide counting mode decision circuitry and a counting mode decision method.

### SUMMARY

According to a first aspect, the disclosure provides counting mode decision circuitry configured to:
determine, for at least one imaging element, a photon number in a first photon counting mode of at least two photon counting modes which, in a standard operation mode, are applied after each other; and
skip a second photon counting mode of the at least two photon counting modes, if the photon number in the first photon counting mode exceeds a predetermined threshold, thereby deviating from the standard operation mode.

According to a second aspect, the disclosure provides a counting mode decision method comprising:
determining, for at least one imaging element, a photon number in a first photon counting mode of at least two photon counting modes which, in a standard operation mode, are applied after each other; and
skipping a second photon counting mode of the at least two photon counting modes, if the photon number in the first photon counting mode exceeds a predetermined threshold, thereby deviating from the standard operation mode.

Further aspects are set forth in the dependent claims, the drawings and the following description.

### BRIEF DESCRIPTION OF THE DRAWINGS

Embodiments are explained by way of example with respect to the accompanying drawings, in which:

FIG. 1 shows a simplified diagram of pixel circuitry including a SPAD and a counter;

FIG. 2a shows an example of a general diagram of a two-pixel arrangement in which counters are not shared;

FIG. 2b shows an example of a general diagram of a two-pixel arrangement in which counters are shared for a first SPAD;

FIG. 2c shows an example of a general diagram of a two-pixel arrangement in which counters are shared for a second SPAD;

FIG. 3 depicts an embodiment of a counter mode sequence according to a standard operation mode of an imaging device according to the present disclosure;

FIG. 4 depicts a graph of a Poisson distribution which may be applied as a light distribution of a SPAD;

FIG. 5 depicts an embodiment of counting mode decision circuitry according to the present disclosure;

FIG. 6 depicts an embodiment of a counting mode decision method according to the present disclosure in a block diagram;

FIG. 7 depicts a further embodiment of a counting mode decision method according to the present disclosure in a block diagram, in which two LCBL modes are carried out and an SCBL mode is then skipped; and

FIG. 8 depicts a further embodiment of a counting mode decision method according to the present disclosure in a block diagram, in which a photon number is not sufficient and thus, a counting mode is not skipped.

### DETAILED DESCRIPTION OF EMBODIMENTS

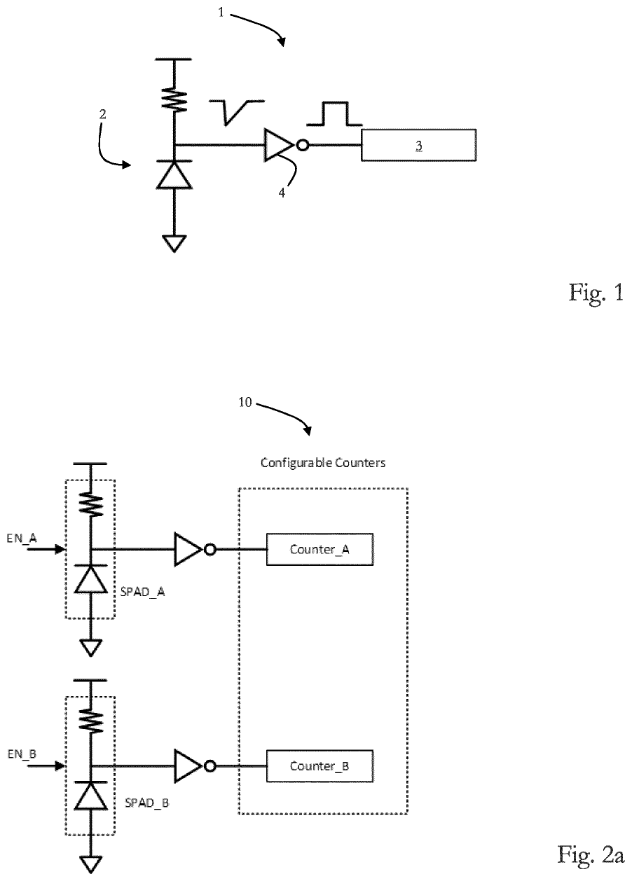

Before a detailed description of the embodiments starting with FIG. 1 is given, general explanations are made.

As mentioned in the outset, SPAD (single photon avalanche diode) based photon counting is generally known, as well as combining it with HDR (high dynamic range) photo detection. It has been recognized that due to the ability of a SPAD of detecting an environment, HDR may be possible to achieve with a SPAD.

However, it has been recognized that due to the Geiger biasing of SPADs, a SPAD may be triggered significantly often, such that a power consumption may be high.

It has thus been recognized that it may be desirable to provide circuitry and a method which combines the two technologies of single photon counting with high dynamic range photo detection. It has further been recognized that a combination may be possible by deciding when to skip one of the two modes or to skip single exposures in different counting modes.

Moreover, it has been recognized that, due to a trend of SPAD pixels getting smaller, unnecessary circuitry may need to be avoided. Also, in order to not occupy too much space on a chip/sensor, counter lengths may need to become smaller for further reducing the pixel size.

Hence, it has been recognized that pixels may share counters, thereby decreasing the number of counters and thus, reducing the pixel size.

Therefore, some embodiments pertain to counting mode decision circuitry configured to: determine, for at least one imaging element, a photon number in a first photon counting mode of at least two photon counting modes which, in a standard operation mode, are applied after each other; and skip a second photon counting mode of the at least two photon counting modes, if the photon count in the first photon counting mode exceeds a predetermined threshold, thereby deviating from the standard operation mode.

Circuitry may pertain to any entity or multitude of entities which may be utilized for generating signals, such that a counting and a decision according to the present disclosure may be carried out. For example, the circuitry may be based on a processor, such as a CPU (central processing unit), GPU (graphics processing unit), based on an FPGA (field-programmable gate array), or the like. Also, different types of such entities may be used in order to carry out the present disclosure, such as a processor which includes at least one CPU and one GPU, such that tasks may be distributed among them. Moreover, the circuitry may include corresponding wiring and/or connections in order to transmit signals, as it is generally known. For example, the present disclosure may be applied in camera systems. Hence, the present disclosure may also pertain to a sensor, a camera and/or a photo detection system including counting mode decision circuitry according to the present disclosure.

The circuitry may be configured to decide for a counting mode, i.e., a mode indicating how photons, which may be incident on an imaging element (e.g., SPAD (single photon avalanche diode), APD (avalanche photodiode), or the like), shall be counted. For example, if it is known in advance that not many photons (i.e., a number below a predetermined threshold) will be counted, a “low photon number”-counting mode may be applied. In such a mode, a photon counter with a low bit length may be used. On the other hand, if ambient light is high (i.e., above a predetermined threshold), a “high photon number”-counting mode may be applied, which may be based on a photon counter with a higher bit length.

In some embodiments, the circuitry is configured to determine a photon number in a first photon counting mode of at least two photon counting mode. In a standard operation mode, these two modes may (usually) be applied after each other, i.e., a first photon mode may be applied first (e.g., the high photon number-counting mode) and then, a second photon counting mode may be applied (e.g., the low photon number-counting mode). Such a standard operation mode may be based on the approach to first have a coarse photon number estimation and then a fine photon number estimation, or the like.

In some embodiments, the photon number in the first counting mode may be sufficiently high (or low) such that, in contrast to the standard operation mode, the second photon counting mode may not be applied, i.e., it may be skipped.

In some embodiments, the at least two photon counting modes may include a long counter bit length (LCBL) mode and a short counter bit length (SCBL) mode, as discussed above.

It should be noted that there may also be other counting modes, such as an intermediate bit length, very short or very long bit length mode, or the like. Moreover, there may be sub-modes of the respective “main” modes, such as an LCBL A mode, LCBL B mode, SCBL A mode, SCBL B mode, or the like, which may, apart from a different counter bit length, may additionally or alternatively be determined based on external circumstances.

Moreover, the modes being carried out after each other should not be construed such that the SCBL mode necessarily needs to follow the first LCBL mode. For example, an LCBL mode may be applied, an intermediate mode may be applied, and then the SCBL mode may be applied, but still, the SCBL mode may be skipped based on the photon count of the SCBL mode.

Moreover, if two LCBL modes are applied, the SCBL mode may be skipped on the first of them, or the like.

However, the present disclosure is not limited to the case discussed above. For example, in low light conditions, it may be sufficient to only carry out a low bit length measurement (e.g., SCBL mode) and if the counter is not saturated, skip a high bit length measurement (e.g., LCBL mode).

In some embodiments, the first photon counting mode is based on the LCBL mode and the second photon counting mode includes the SCBL mode, as discussed herein.

In some embodiments, the LCBL mode is based on at least two counters which are shared for the at least one imaging element.

According to the present disclosure, (re-)configurable counters may be used. For example, for the simplest case of two counters and two imaging elements (e.g., SPADs), each of the two imaging elements may have an assigned counter in the SCBL mode. However, in the LCBL mode, the two counters may be assigned to only one of the imaging elements, such that the other imaging element may have no counter. In such an embodiment, the two counters may be connected in series, thereby increasing the bit length.

However, the present disclosure may not be limited to that case. For example, in order to not sacrifice resolution as in the above example, several (at least two) counters may be used for one imaging element, such that a long counter bit length can be achieved for each imaging element. In such a case, at least two short counters may be reconfigurable as a long counter, or, a short counter may be provided and a long counter, wherein it may be possible to switch between these two counters.

In some embodiments, the at least one imaging element is based on a single-photon avalanche diode, as discussed herein. Generally, the present disclosure may be applied with any circuitry which provides for the counting of (single) photons.

In some embodiments, in the SCBL mode, the two counters are configured to count photons for at least two different imaging elements, as discussed herein.

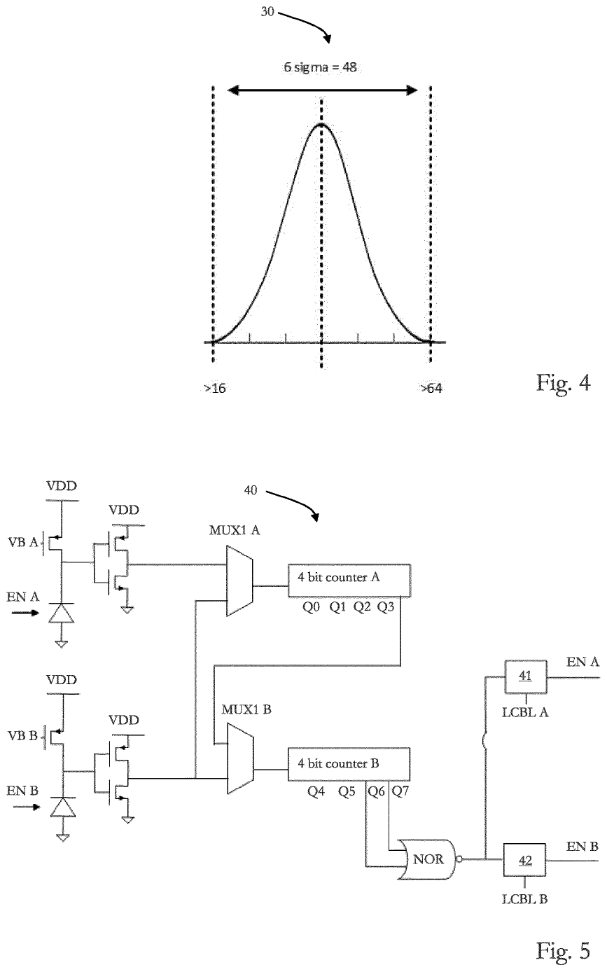

In some embodiments, the predetermined threshold is based on a standard deviation from the photon number, as will be discussed with reference to FIG. 4.

In some embodiments, the circuitry further includes a logic element which, when the counting mode decision circuitry operates with two consecutive LCBL modes, is configured: generate a skip signal for skipping the SCBL mode, if the two LCBL modes indicate that the predetermined threshold is exceeded.

In some embodiments, the logic element is further configured to store a logic value in a memory, wherein the logic value is indicative of an outcome of a comparison of the two consecutive LCBL modes.

However, it should be noted that also a different element than the logic element may be used for generating the skip signal and/or for storing the logic value. Such a different element may use the signal from the logic element, but may be separated from it.

In some embodiments, the logic element is an exclusive OR (NOR) gate.

Some embodiments pertain to a counting mode decision method including: determining, for at least one imaging element, a photon number in a first photon counting mode of at least two photon counting modes which, in a standard operation mode, are applied after each other; and skipping a second photon counting mode of the at least two photon counting modes, if the photon count in the first photon counting mode exceeds a predetermined threshold, thereby deviating from the standard operation mode, as discussed herein.

The method may be carried out with counting mode decision circuitry according to the present disclosure.

In some embodiments, the at least two photon counting modes include a long counter bit length (LCBL) mode and a short counter bit length (SCBL) mode, as discussed herein. In some embodiments, the first photon counting mode is based on the LCBL mode and the second photon counting mode includes the SCBL mode, as discussed herein. In some embodiments, the LCBL mode is based on at least two counters which are shared for the at least one imaging element, as discussed herein. In some embodiments, the at least one imaging element is based on a single-photon avalanche diode, as discussed herein. In some embodiments, in the SCBL mode, the two counters are configured to count photons for at least two different imaging elements, as discussed herein. In some embodiments, the predetermined threshold is based on a standard deviation from the photon number, as discussed herein. In some embodiments, when the counting mode decision method is based on two consecutive LCBL modes, the counting mode decision method further includes: generating a skip signal for skipping the SCBL mode, if the two LCBL modes indicate that the predetermined threshold is exceeded, as discussed herein. In some embodiments, the method further includes storing a logic value in a memory, wherein the logic value is indicative of an outcome of a comparison of the two consecutive LCBL modes, as discussed herein. In some embodiments, the generation of the skip signal is carried out based on an exclusive OR (NOR) gate.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

It should be noted that an image sensor including or being connectable to circuitry according to the present disclosure may be provided, which may not be limited to any sensor type. Hence, according to the present disclosure, an image sensor may be based on a single layer sensor, stacked sensor, back-side illuminated sensor, front-side illuminated sensor, or the like. Moreover, the SPADs of the present disclosure may be external clock controlled or non-external clock controlled SPADs.

Moreover, the circuitry and the SPAD(s) may be provided on a same wafer or in different (stacked) wafers. The polarity of the SPADs should also not be construed as binding since an anode or a cathode detection may be carried out.

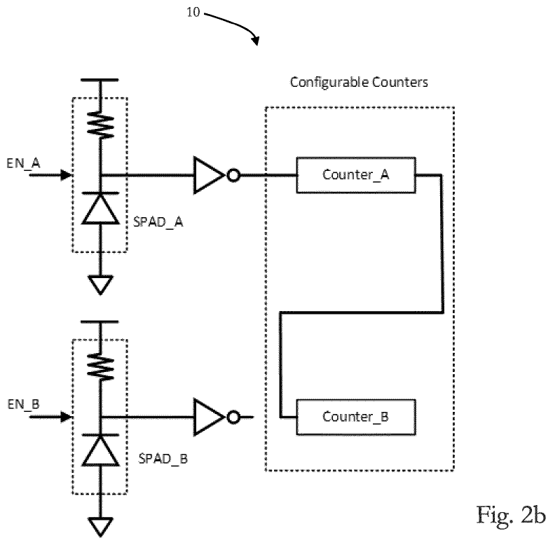

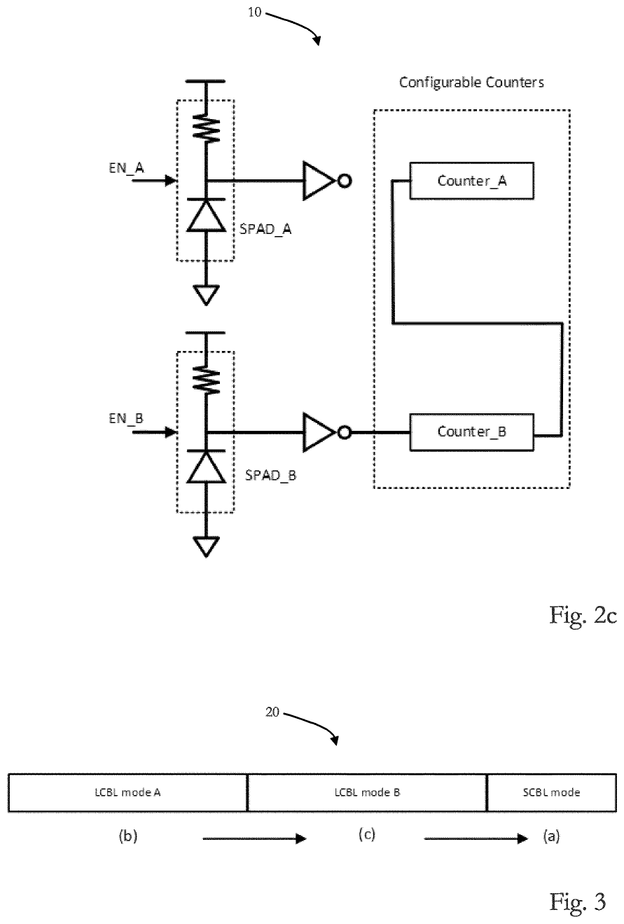

The signals EN_A and EN_B (c.f. FIG. 2 or 5) may be any signal, such as an external clock signal to the SPADs, without limiting the present disclosure in that regard.

The modes may depend on the control of the SPADs. For example, the SCBL mode in a non-external clock-controlled mode may refer to short time exposure, while the LCBL mode may refer to long-time exposure.

On the other hand, SCBL in external clock-controlled mode may refer to long time exposure while the LCBL mode may refer to short time exposure.

For example, if the SPAD is configured to trigger only once within one clock period, SCBL may correspond to long-time exposure. However, if the SPAD is configured to trigger multiple times within one clock period, SCBL may correspond to short time exposure while LCBL may correspond to long time exposure.

Returning to FIG. 1, there is shown a simplified diagram of pixel circuitry 1 including a SPAD 2 and a counter 3.

In this embodiment, the SPAD 2 is biased at Geiger-mode, such that the SPAD 2 is configured to generate a pulse at its anode, i.e., a so-called event is generated in SPAD 2. This pulse is filtered by a comparator/inverter 4 (or other interface circuits) and then the event is counted by the counter 3.

It should be noted that for simplification purposes, the SPAD 2 is depicted as a passive quenched structure, but it may be active quenched or external clock controlled quenched or any other kind of quenched. Moreover, the present disclosure is not limited to SPADs. For example, an APD or any other imaging element may be used with which a digital event may be generated similarly. Furthermore, the counter 3 is simplified by a counter block. The counter 3 may be based on a ripple counter, LFSR (Linear Feedback Shift Register) counter or any other circuits that can accumulate events that is generated by the SPAD 2.

As discussed above, counter share within a macro-pixel is utilized, in some embodiments, when high photon count is expected. This corresponds to the long exposure in a classic multi-frame HDR (high dynamic range) technique or in non-external controlled SPAD photon counting sensors. As in external clock controlled SPAD sensors, shorter exposure may have higher counts because of higher external controlled clock frequency, this mode may be called long counter bit length (LCBL) mode. Accordingly, for shorter exposure in non-external clock-controlled or longer exposure in external clock-controlled cases, it may be called short counter bit length (SCBL) mode.

FIG. 2a shows an example of a general diagram of a two-pixel arrangement 10. EN_A and EN_B represent signals for enabling/disabling of SPAD_A (EN_A) and SPAD_B (EN_B) respectively. Counter_A and Counter_B respectively share the counts of SPAD_A (Counter_A) and SPAD_B (Counter_B). It should be understood that the counters are configurable, as will be discussed under reference of FIGS. 2B and 2C.

FIG. 2b shows a serial connection of Counter_A and Counter_B, wherein the two counters are both connected to SPAD_A (Counter_A is connected to SPAD_A and Counter_B is connected to Counter_A). Hence, SPAD_B is not used in this embodiment.

FIG. 2c shows the other case in which SPAD_A is not used since the counters are connected to SPAD B.

FIG. 3 depicts an embodiment of a counter mode sequence 20 according to a standard operation mode of an imaging device. The letters below the respective modes indicate the counter configuration of FIGS. 2a to 2c, i.e. in FIG. 3, (a) corresponds to the counter configuration of FIG. 2a, (b) corresponds to the counter configuration of FIG. 2b, and (c) corresponds to the counter configuration of FIG. 2c.

Hence, first, a counting for SPAD_B is carried out in LCBL mode A. Subsequently, a counting for SPAD_A is carried out in LCBL mode B, and then, a counting for both SPADs is carried in For deciding, whether the SCBL mode should be skipped and thus, whether to deviate from the standard operation mode, some assumptions are explained first, for an embodiment in which the counter length for each SPAD is four bit in SCBL mode and thus it is eight bit in LCBL mode.

For example, if a count number in an LCBL mode is 01000000 (in binary) or more (i.e., sixty-four in decimal), an assumed noise may correspond to at least one standard deviation. A corresponding distribution graph is shown in FIG. 4. For SPADs, a Poisson distribution is assumed, but the present disclosure may be applicable to any statistic distribution.

Hence, one standard deviation may correspond to eight counts (since it is the square root of the count number).

For a very high confidence, six standard deviations may be assumed for the noise signal. Hence, the count number with the high confidence may correspond to 64−6*√64=16 (sixty-four minus six times square root of sixty-four equals sixteen), which means in the SCBL mode of four bit, the counter will be saturated (also called “hot”). Therefore, the SCBL counting can be avoided to save power because it will output 1111 according to the current assumption.

Hence, in this embodiment, the threshold of the photon number is sixty-four.

However, other assumptions for the standard deviation may be made according to the circumstances and according to the respective counter bit lengths, as explained herein.

FIG. 5 depicts an embodiment of counting mode decision circuitry 40 according to the present disclosure, wherein the left part (until the counters) corresponds to the circuitry discussed under reference of FIGS. 2a to 2c, wherein, in order to establish the reconfigurability of the counters, multiplexers MUX1 A and MUX1B are provided which interconnect the counters. The counters A and B are each four bit counters with bits named Q0 to Q7, i.e., counter A has the bits Q0 to Q3 and counter B has the bits Q4 to Q7.

In this embodiment, A NOR gate is set after the output of counter B to monitor outputs of the counters in the LCBL mode A and LCBL mode B. The NOR gates is configured to output a logical zero, if Q3*Q2 is larger or equal to 01 (in binary) or 10 (in binary) or 11 (in binary).

Furthermore, the output of the NOR gate is stored in a memory cell 41 or 42, respectively, i.e., latched and processed with other circuits to generate the signals EN_A and EN_B. If the two MSBs (MSB: “most significant bit”) of Q7 and Q6 are 01 or 10 or 11 in LCBL mode A or in LCBL mode B, then the output of the NOR gate is 0. This output is stored in the memory cell to combine it with other possible control signals with extra circuits to control EN_A and EN_B, respectively. As EN A or EN_B are 0 because the corresponding NOR output is 0, the SPAD is disabled in the next SCBL mode.

If the two MSBs of Q7 and Q6 are 00, then the output of the NOR gate is 1. This logic value is also stored in the memory cell and used to enable the SPAD device in the upcoming SCBL mode because no hot pixel is detected. By doing so, unmeaningful counts in SCBL are avoided and thus, power is saved. Of course, during a readout phase, we can readout the data of the memory cell and know the state of the SCBL counting. For example, if it is decided to skip the SCBL mode, a counter's data may include only (logical) ones, such that it may be superfluous to read such a part of the data and full ones may be directly added at a host.

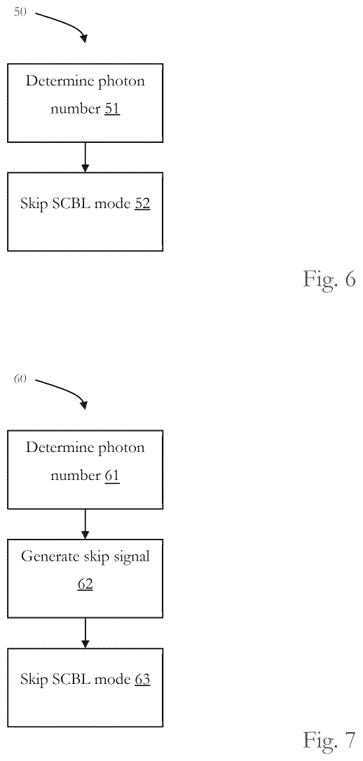

FIG. 6 depicts a counting mode decision method 50 according to the present disclosure in a block diagram.

At 51, a photon number is determined for an imaging element in an LCBL mode, as discussed herein.

At 52, an SCBL mode is skipped because the photon number exceeds a predetermined threshold.

FIG. 7 depicts a counting mode decision method 60 according to the present disclosure in a block diagram. In the method of FIG. 7, two LCBL modes are carried out and an SCBL mode is then skipped based on a logic decision of a NOR gate, as discussed herein.

At 61, a photon number is determined for an imaging element in two consecutive LCBL modes, as discussed herein.

At 62, a skip signal is generated based on a logic decision of a NOR gate, which indicates that the photon number is sufficient to skip the SCBL mode.

At 62, the SCBL mode is skipped.

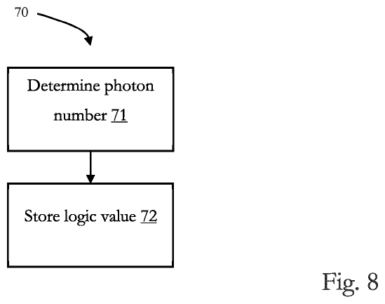

FIG. 8 depicts a counting mode decision method 70 according to the present disclosure in a block diagram, in which a photon number is not sufficient.

At 71, a photon number is determined for an imaging element in two consecutive LCBL modes, as discussed herein, which are compared with a NOR gate.

At 72, a logic value of a NOR gate is stored in a memory, as discussed herein.

It should be recognized that the embodiments describe methods with an exemplary ordering of method steps. The specific ordering of method steps is however given for illustrative purposes only and should not be construed as binding. and changes of the ordering of method steps may be apparent to the skilled person.

Please note that the division of the circuitry 40 into its units is only made for illustration purposes and that the present disclosure is not limited to any specific division of functions in specific units. For instance, the control circuitry 40 could be implemented by a respective programmed processor, field programmable gate array (FPGA) and the like.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.
(1) Counting mode decision circuitry configured to:
   determine, for at least one imaging element, a photon number in a first photon counting mode of at least two photon counting modes which, in a standard operation mode, are applied after each other; and
   skip a second photon counting mode of the at least two photon counting modes, if the photon number in the first photon counting mode exceeds a predetermined threshold, thereby deviating from the standard operation mode.
(2) The counting mode decision circuity of (1), wherein the at least two photon counting modes include a long counter bit length (LCBL) mode and a short counter bit length (SCBL) mode.
(3) The counting mode decision circuitry of (2), wherein the first photon counting mode is based on the LCBL mode and the second photon counting mode includes the SCBL mode.
(4) The counting mode decision circuitry of (2) or (3), wherein the LCBL mode is based on at least two counters which are shared for the at least one imaging element.
(5) The counting mode decision circuitry of (4), wherein the at least one imaging element is based on a single-photon avalanche diode.
(6) The counting mode decision circuitry of (4) or (5), wherein, in the SCBL mode, the two counters are configured to count photons for at least two different imaging elements.
(7) The counting mode decision circuitry of anyone of (1) to (6), wherein the predetermined threshold is based on a standard deviation from the photon number.
(8) The counting mode decision circuitry of anyone of (2) to (7), further comprising a logic element which, when the counting mode decision circuitry operates with two consecutive LCBL modes, is configured:
   generate a skip signal for skipping the SCBL mode, if the two LCBL modes indicate that the predetermined threshold is exceeded.
(9) The counting mode decision circuitry of (8), wherein the logic element is further configured to:
   store a logic value in a memory, wherein the logic value is indicative of an outcome of a comparison of the two consecutive LCBL modes.
(10) The counting mode decision circuitry of (8) or (9), wherein the logic element is an exclusive OR (NOR) gate.
(11) A counting mode decision method comprising:
   determining, for at least one imaging element, a photon number in a first photon counting mode of at least two photon counting modes which, in a standard operation mode, are applied after each other; and
   skipping a second photon counting mode of the at least two photon counting modes, if the photon number in the first photon counting mode exceeds a predetermined threshold, thereby deviating from the standard operation mode.
(12) The counting mode decision method of (11), wherein the at least two photon counting modes include a long counter bit length (LCBL) mode and a short counter bit length (SCBL) mode.
(13) The counting mode decision method of (12), wherein the first photon counting mode is based on the LCBL mode and the second photon counting mode includes the SCBL mode.
(14) The counting mode decision method of (12) or (13), wherein the LCBL mode is based on at least two counters which are shared for the at least one imaging element.
(15) The counting mode decision method of (14), wherein the at least one imaging element is based on a single-photon avalanche diode.
(16) The counting mode decision method of (14) or (15), wherein, in the SCBL mode, the two counters are configured to count photons for at least two different imaging elements.
(17) The counting mode decision method of anyone of (11) to (16), wherein the predetermined threshold is based on a standard deviation from the photon number.
(18) The counting mode decision method of anyone of (12) to (17), wherein, when the counting mode decision method is based on two consecutive LCBL modes, the counting mode decision method further comprises:
   generating a skip signal for skipping the SCBL mode, if the two LCBL modes indicate that the predetermined threshold is exceeded.
(19) The counting mode decision method of (18), further comprising:
   storing a logic value in a memory, wherein the logic value is indicative of an outcome of a comparison of the two consecutive LCBL modes.
(20) The counting mode decision method of (18) or (19), wherein the generation of the skip signal is carried out based on an exclusive OR (NOR) gate.
(21) A computer program comprising program code causing a computer to perform the method according to anyone of (11) to (20), when being carried out on a computer.
(22) A non-transitory computer-readable recording medium that stores therein a computer program product, which, when executed by a processor, causes the method according to anyone of (11) to (20) to be performed.

1. Counting mode decision circuitry configured to:
determine, for at least one imaging element, a photon number in a first photon counting mode of at least two photon counting modes which, in a standard operation mode, are applied after each other; and
skip a second photon counting mode of the at least two photon counting modes, if the photon number in the first photon counting mode exceeds a predetermined threshold, thereby deviating from the standard operation mode.

2. The counting mode decision circuity of claim 1, wherein the at least two photon counting modes include a long counter bit length (LCBL) mode and a short counter bit length (SCBL) mode.

3. The counting mode decision circuitry of claim 2, wherein the first photon counting mode is based on the LCBL mode and the second photon counting mode includes the SCBL mode.

4. The counting mode decision circuitry of claim 2, wherein the LCBL mode is based on at least two counters which are shared for the at least one imaging element.

5. The counting mode decision circuitry of claim 4, wherein the at least one imaging element is based on a single-photon avalanche diode.

6. The counting mode decision circuitry of claim 4, wherein, in the SCBL mode, the two counters are configured to count photons for at least two different imaging elements.

7. The counting mode decision circuitry of claim 1, wherein the predetermined threshold is based on a standard deviation from the photon number.

8. The counting mode decision circuitry of claim 2, further comprising a logic element which, when the counting mode decision circuitry operates with two consecutive LCBL modes, is configured:
generate a skip signal for skipping the SCBL mode, if the two LCBL modes indicate that the predetermined threshold is exceeded.

9. The counting mode decision circuitry of claim 8, wherein the logic element is further configured to:
store a logic value in a memory, wherein the logic value is indicative of an outcome of a comparison of the two consecutive LCBL modes.

10. The counting mode decision circuitry of claim 8, wherein the logic element is NOR gate.

11. A counting mode decision method comprising:
determining, for at least one imaging element, a photon number in a first photon counting mode of at least two photon counting modes which, in a standard operation mode, are applied after each other; and
skipping a second photon counting mode of the at least two photon counting modes, if the photon number in the first photon counting mode exceeds a predetermined threshold, thereby deviating from the standard operation mode.

12. The counting mode decision method of claim 11, wherein the at least two photon counting modes include a long counter bit length (LCBL) mode and a short counter bit length (SCBL) mode.

13. The counting mode decision method of claim 12, wherein the first photon counting mode is based on the LCBL mode and the second photon counting mode includes the SCBL mode.

14. The counting mode decision method of claim 12, wherein the LCBL mode is based on at least two counters which are shared for the at least one imaging element.

15. The counting mode decision method of claim 14, wherein the at least one imaging element is based on a single-photon avalanche diode.

16. The counting mode decision method of claim 14, wherein, in the SCBL mode, the two counters are configured to count photons for at least two different imaging elements.

17. The counting mode decision method of claim 11, wherein the predetermined threshold is based on a standard deviation from the photon number.

18. The counting mode decision method of claim 12, wherein, when the counting mode decision method is based on two consecutive LCBL modes, the counting mode decision method further comprises:
generating a skip signal for skipping the SCBL mode, if the two LCBL modes indicate that the predetermined threshold is exceeded.

19. The counting mode decision method of claim 18, further comprising:
storing a logic value in a memory, wherein the logic value is indicative of an outcome of a comparison of the two consecutive LCBL modes.

20. The counting mode decision method of claim 18, wherein the generation of the skip signal is carried out based on NOR gate.
